(19) United States
(12) Patent Application Publication
(10) Pub. No.: US 2020/0129874 A1
(43) Pub. Date: Apr. 30, 2020

(54) SOFT PRODUCTS WITH ELECTROMECHANICAL SUBSYSTEM

(71) Applicant: Robert E. Culver, II, Akron, OH (US)

(72) Inventor: Robert E. Culver, II, Akron, OH (US)

(21) Appl. No.: 16/686,189

(22) Filed: Nov. 17, 2019

Related U.S. Application Data
(63) Continuation-in-part of application No. 15/959,243, filed on Apr. 22, 2018, now Pat. No. 10,500,512.
(60) Provisional application No. 62/602,371, filed on Apr. 21, 2017.

(51) Int. Cl. A63H 3/00; A63H 3/02; A63H 3/28; G06F 3/16

(52) U.S. Cl. CPC A63H 3/005; A63H 3/02; A63H 2200/00; G06F 3/167; A63H 3/28

(57) ABSTRACT

A soft product having an electronic subsystem system that enables transmission and reception of signals and data, a speech recognition subsystem for processing speech signals, a video recognition subsystem for processing images received from a camera subsystem, electromechanical components in the member parts controlled by a microprocessor to activate in a specific way in response to at least one of speech or a gesture communicated from the user to the soft product, a storage subsystem and power subsystem. The soft product can be provided with cup-holders embedded into limbs as the stuffed animal is oriented in an upright position.

### CROSS-REFERENCE TO RELATED APPLICATIONS

This application is a Continuation-in-Part of pending U.S. patent application Ser. No. 15/959,243 filed Apr. 22, 2018 and entitled “SOFT PRODUCTS HAVING ITEM HOLDERS AND CLOSABLE COMPARTMENTS”, which claims the benefit of U.S. Provisional Patent Application Ser. No. 62/602,371 filed Apr. 21, 2017 and entitled “Indeed inflammation intimacy Stuffed animal snack shelf that folds down to hold cups(bottles) and snack bowl. tray can be either fixed or de-tatchable”. The entireties of the above-mentioned applications are incorporated by reference herein.

### BACKGROUND

Soft products such as stuffed animals for children and adults are abundant in the marketplace for use indoors and outdoors. In particular, soft products in the form of animals such as bears, horses, puppies, etc., are available, but targeted primarily for use by children. However, products produced for children, teens, and adults, lack utility other than typical interactions such as touching, holding, carrying, hugging, etc. Moreover, parents are no longer satisfied with such minimal utility in these products. A recognized shortcoming of existing soft products are features that provide enhanced utility.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed innovative products (e.g., soft) include product features that facilitate the use of items (e.g., child toys, food items, non-food items, etc.) by way of stuffed creatures (“comfort creatures”). In support thereof, the products can incorporate features such as a compartment to accommodate child and adult consumable (edible) items such as food and/or drink, and/or non-consumable items so as to hold small gift items for presentation or gifting to another person.

In other words, these features can include, but are not limited to, containers and compartments such as a (snack) bowl, drink holder, a compartment in which to house/secret away small items, a way to hold baskets or the like in which to set and present items such as flowers, candy, and so on.

In one implementation, a product as a soft stuffed animal (a creature) can be provided in which cup holders are embedded in one or more limbs of the stuffed animal. When the stuffed animal is oriented in a suitable upright orientation, a container of liquid (e.g., water, drinks), for example, can be placed into a cup holder and used therefrom. Thus, drink containers can be placed into the cup holders and positioned in a stable manner (e.g., non-spill) for use by the child and/or adult.

In another implementation, the stuffed animal includes a compartment system as a single unit that comprises a compartment and compartment cover (e.g., shaped as a bowl). The compartment part of the compartment system is embedded into the front abdominal area of a main body of the stuffed animal, such that the compartment cover securely encloses (stays closed on its own) any item in the compartment while the stuffed animal is tossed about or handled. Once properly oriented, the compartment cover can be lifted up and back (e.g., in a hinged manner) to expose the item(s) in the compartment, for consumption or access by the intended person (e.g., a child).

It can be the case that the compartment cover is not hingedly designed to the compartment, rather the compartment is embedded into the front abdomen of the main body of the animal, so that the compartment cover (e.g., bowl shaped) is hingedly rotated up to engage the compartment and securely capture the item(s) enclosed in the compartment. This can be a handling or carrying method for the stuffed creature and product until such time as the user chooses to expose the item(s) to the intended person and in the intended way.

In yet another implementation, the stuffed creature can be shaped as a marine animal such as a dolphin, where the “breathing hole” of the dolphin is fitted to accommodate a cup holder, and the dorsal fin is or includes the compartment cover (over an embedded compartment), which can be removed and/or folded back to expose the compartment that holds an item such as a food product and/or small non-consumable item (e.g., a ball, gift, basket, etc.).

In still another implementation, the front and/or back abdominal section (main body) of the stuffed animal can accommodate a drink container (e.g., a cup/cover having a straw, a canned drink, etc.). Thus, the animal becomes the means by which the user holds the drink container and consumes the liquid therefrom, or holds dry food product in a jar, or other container type for consumption, gifting a non-consumable item, etc.

In another implementation, the front abdominal section of the main body of a creature includes a tray system having a housing, a frame for a flip-down tray, and the flip-down tray, which serves to hold one or more drink containers and on which food or other items can be set (like a miniature table top), and that when flipped up in a closed position, can be latched closed. The tray system can be made detachable from the creature to use separately (standalone) from the creature or to enable use of the stuffed creature without the tray system.

In still another implementation, the detachable tray and drink holder system can employ a multi-point attachment mechanism to the stuffed animal by way of one or more of the main body and limbs. For example, hook-and-loop material can be used as the attachment mechanism between the tray/holder and the main body, the tray/holder and the inside areas of the arms/legs, and/or the tray/holder and top areas of the legs of the stuffed creature.

In other words, a soft product in a shape of a creature is provided, comprising: a product cover fabricated into the shape of the creature and member parts of the creature, the product cover stuffed with stuffing material to hold the shape of the creature and the member parts in a predetermined orientation; and a compartment system formed into a member part and capable of receiving an item, the compartment system comprising a compartment into which the item is placed and a compartment cover that mates to the compartment to capture the item in the compartment and enable access to the item.

Alternatively, a product in a shape of a creature is provided, comprising: a product cover fabricated into the shape of the creature and member parts of the creature, the member parts include at least a head and a main body, the product cover stuffed with stuffing material to hold the shape of the creature and the member parts; and a compartment and a compartment cover formed into the main body member part and capable of receiving an item, the compartment cover attached to the compartment to enclose the item in the compartment and enable access to the item.

In yet another implementation, a product in a shape of a creature is provided, comprising: a product cover fabricated into the shape of the creature and member parts of the creature, the member parts include at least a head and a main body, the product cover stuffed with stuffing material to maintain the shape of the creature, maintain orientation of the creature, and maintain orientation of the member parts relative to the main body; and a compartment and a compartment cover formed into the main body member part, through the product cover, and capable of receiving an item, the compartment cover attached to the compartment to enclose the item in the compartment for storage and enable access to the item when open, the compartment and compartment cover removable from main body for use as a standalone unit.

In one implementation, a soft product is disclosed and described herein, comprising: a product cover fabricated into the shape of a creature and member parts of the creature, the member parts include a main body and an appendage of the main body; a compartment system formed into the main body, the compartment system comprising a compartment into which an item can be placed and a compartment cover that mates to the compartment to enable access to the item; a holder constructed into a member part, the member part at least one of the head or other appendage; and an electromechanical subsystem located inside the soft product, and for processing at least one of audio, video, or communications signals.

The electromechanical subsystem is accessible via the compartment system. The electromechanical subsystem includes an audio output component constructed into a member part to output audio signals. The electromechanical subsystem includes an audio input component constructed into a member part to receive audio signals. The electromechanical subsystem includes a transceiver system that enables transmission and reception of the audio, video, and communications signals. The electromechanical subsystem includes at least one of an audio or video player subsystem for processing and playing audio and video data for presentation to a user.

The electromechanical subsystem includes at least one port for receiving a data device from which to access and play at least one of audio or video data. The electromechanical subsystem includes at least one network port via which at least one of wired or wireless network communication is enabled. The electromechanical subsystem enables wireless communication with at least one of a cellular-capable or non-cellular device from which to receive and play at least one of audio, data, or video signals, and to which to transmit at least one of audio, data, or video signals.

The electromechanical subsystem includes a mesh network node capability that functions as a mesh node in a mesh network. The electromechanical subsystem includes a display which enables the presentation of video signals. The electromechanical subsystem includes a speech recognition subsystem for processing speech signals from a user and outputting an audio signal to the user. The electromechanical subsystem includes a data storage subsystem that enables the storage of software data, software data updates, and user-supplied data. The electromechanical subsystem includes electromechanical components in the member parts that are controlled by a microprocessor to activate in a specific way in response to at least one of speech or a gesture communicated from the user to the soft product.

In another implementation, a soft product is disclosed and described herein, comprising: a product cover fabricated into the shape of a creature and member parts of the creature, the member parts include a main body and an appendage of the main body; a compartment system formed into the main body, the compartment system comprising a compartment into which an item can be placed and a compartment cover that mates to the compartment to enable access to the item; a holder constructed into a member part, the member part at least one of the head or other appendage; and an electromechanical subsystem located inside the soft product, and for processing at least one of audio, video, or communications signals.

The electromechanical subsystem includes: an audio output component constructed into a member part to output audio signals; a transceiver system that enables transmission and reception of the audio, video, and communications signals; at least one of an audio or video player subsystem for playing audio and video data for presentation to a user; at least one port for receiving a data device from which to access and play at least one of audio or video data; and a data storage subsystem that enables the storage of software programs and data, software program and data updates, and, user-supplied program and data inputs.

The electromechanical subsystem is accessible via the compartment system. The electromechanical subsystem includes an audio input component constructed into a member part to receive audio signals. The electromechanical subsystem includes at least one network port via which at least one of wired or wireless network communication is enabled. The electromechanical subsystem enables wireless communication with at least one of a cellular-capable or non-cellular device from which to receive and play at least one of audio, data, or video signals, and to which to transmit at least one of audio, data, or video signals.

In yet another implementation, a soft product is disclosed and described herein, comprising: a product cover fabricated into the shape of a creature and member parts of the creature, the member parts include a main body and an appendage of the main body; a compartment system formed into the main body, the compartment system comprising a compartment into which an item can be placed and a compartment cover that mates to the compartment to enable access to the item; a holder constructed into a member part, the member part at least one of the head or other appendage; and an electromechanical subsystem located inside the soft product, and for processing at least one of audio, video, or communications signals.

The electromechanical subsystem includes: a transceiver system that enables transmission and reception of the audio, video, and communications signals; a speech recognition subsystem for processing speech signals from a user and outputting an audio signal to the user; a video recognition subsystem for processing images received from a camera subsystem; electromechanical components in the member parts controlled by a microprocessor to activate in a specific way in response to at least one of speech or a gesture communicated from the user to the soft product; and a data storage subsystem that enables the storage of software programs and data, software program and data updates, and, user-supplied program and data inputs.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a product in accordance with the disclosed innovation.

FIG. 2 illustrates the product as a bear with a compartment cover in an open position.

FIG. 3 illustrates the product as a primate.

FIG. 4 illustrates the product as a marine animal.

FIG. 5 illustrates the product as a creature that includes a tray system.

FIG. 6 illustrates the creature of FIG. 5 where the tray system is removable.

FIG. 7 illustrates the creature of FIG. 5 where the tray system is captured and stabilized by the creature limbs.

FIG. 8 illustrates a soft product in accordance with the disclosed architecture that can incorporate electronics capabilities and features as described herein.

FIG. 9 illustrates a soft product mesh network capability, in accordance with the disclosed architecture that incorporates electronics capabilities and features as described herein.

FIG. 10 illustrates a soft product system with the soft product creature as the bear in accordance with the disclosed architecture that incorporates electronics capabilities and features as described herein.

FIG. 11 illustrates a block diagram of an electromechanical subsystem in accordance with the disclosed architecture.

### DETAILED DESCRIPTION

The disclosed products (e.g., soft) include product features that facilitate the use of items (e.g., child toys, food items, non-food items, etc.) by way of stuffed (soft) creatures. In support thereof, the products can incorporate features such as a compartment system to accommodate consumable (edible) items such as food and/or drink, and/or non-consumable items so as to hold small gift items, for example, for presentation or gifting to another person. The compartment system can include the compartment and a compartment cover that fits over the compartment to capture (enclose) the item placed in the compartment.

In one implementation, a stuffed animal can be provided in which drink cup holders are embedded in one or more limbs for use when the stuffed animal is oriented in an upright position. Thus, drink containers can be set into the cup holders and positioned in a stable manner according to the orientation of the stuffed animal for use by the user (e.g., child, adult, parent, etc.). Without these features, a parent (a user), for example, would need to carry the food/drink separately and ultimately find a way in which to position the food/drink in a stable manner for access by the child, for example.

While the product is described as mimicking the shape of a creature (any of a living thing), it is to be understood that the product need not be limited to a creature, but can be non-creature such as an object commonly known to not be a living entity, such as a block, box, ball, etc. Thus, a creature is defined to comprise any animal and a human, where the animal is any living thing other than a human such as a plant, mammal, bird, reptile, insect, fish, etc.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. The intention is to cover all modifications, equivalents, and alternatives falling within the spirit and scope of the claimed subject matter.

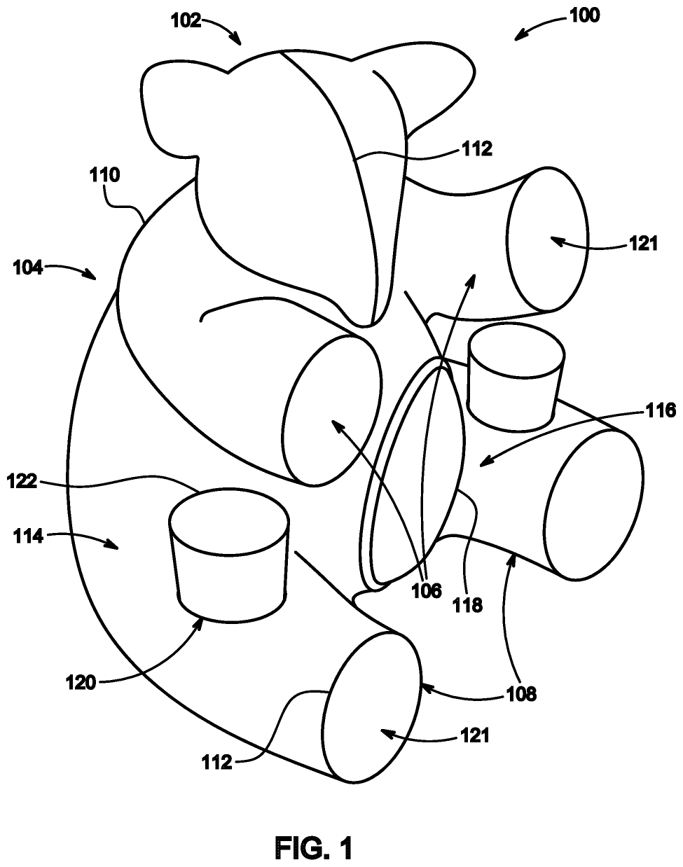

FIG. 1 illustrates a product 100 in accordance with the disclosed innovation. The product 100 can be a soft product which is encased in a flexible and resilient cover of stuffing material and/or fabric. The product 100 serves as a huggable and cuddly article for the user. The user can take (e.g., grasp) the product 100 in its original non-deformed state, then squeeze, embrace, etc., the product 100 to a temporarily deformed state, and once released, the soft product returns to the original non-deformed state.

Continuing, the product 100 can be in the shape of a creature (e.g., bear, gorilla, dolphin, shark, human, etc.). The shape is intended to mimic zero, some, or all the features and appearance of what is commonly-known to be associated with the creature (e.g., human or animal). At a minimum and as described herein, the creature will have at least two body parts: a head, and a main body (includes the neck to the rump).

The other features can be different depending on the creature. For example, where the creature is land-based two-legged or four-legged, the member parts include the head and main body, and can further include other member parts, also referred to as limbs (e.g., arms, legs, etc.). In another example, where the creature is a marine animal, the member parts include the head and main body, and can further include fins (e.g., dorsal, tail, etc.). In yet another example, where the creature is a bird or bird-like and capable/incapable of flight, the member parts include the head and main body, and can further include limbs such as legs and wings.

For example, where the creature is a bear, the bear features and appearance can include a typical bear-like head (with zero, some, or all head features such as nose, eyes, ears, etc.), a main body of the bear (where the main body includes zero, some, or all features from the neck to the tail such as back and underside), front legs (that extend from the main body near the head end and include zero, some, or all features normally observed on or associated with the front legs of a bear, such as paws), and rear legs (that extend from the main body near the tail end and include zero, some, or all features normally observed on or associated with the rear legs of a bear such as paws).

The product 100 of FIG. 1 represents a bear. For the bear creature, the member parts include the head 102 and main body 104, as well as limbs such as front legs 106 and rear (or hind) legs 108. Where the creature is a human, the member parts include the head and main body, as well as limbs such as arms and legs. For a primate (e.g., gorilla, chimpanzee, etc.) the member parts include the head and main body, as well as limbs such as arms and legs.

Additional and/or other more detailed features can be added to the given product 100; however, this is not a requirement, but an enhancement. For example, the head 102 can further include member parts of eyes, ears, and mouth (none of which are shown), and the main body 104 can further include a tail (not shown). (For marsupials, the main body 104 of the marsupial can include an abdominal (belly) pouch, for example, which is not shown here.)

The product 100 comprises a product cover 110 fabricated into the shape of the creature and member parts of the creature. The product cover 110 can include one or more seams 112 where the various parts of the product cover 110 are joined (e.g., stitched, glued, using fasteners, etc.) together into the overall shape of the creature.

The fabricated product cover 110 can be made of any material suitable for the given application. For example, where the product 100 is intended to be used in dry environments (e.g., home) away from water areas such as ponds, pools, bath tubs, etc., to mitigate semi-submersion and full submersion the product cover 110 can be a durable canvas fabric, polyesters, acrylic coated polyesters, nylon, cotton outer layer, and so on. A water-resistant fabric or coating material can also be utilized to mitigate sustained wetness on the cuddly creature by repelling moisture and any form of wetness in dry and wet environments.

The product cover 110 can be stuffed with stuffing material 114 that is designed to hold the shape of the creature and the member parts. Thus, the stuffing material 114 can incorporate suitable stiffness (firmness), and when inserted into the member parts of product cover 110 according to a predetermined stuffing insertion parameter(s), enables the member parts to hold shape and orientation under most instances of user interaction. That is, “holding shape” is intended to mean that member parts such as the limbs maintain orientation as shown and provided at the time of purchase, and throughout extended use of the product 100 over time.

The stuffing material 114 can include any material suitably designed/available to provide the desired product orientation effects for upright use and limb orientations, such as closed-cell foam cushion, unicellular polyurethane foam, and more resilient foam and materials that invite an appealing, cuddly, and squeezable user interaction.

As illustrated in FIG. 1, the stuffing material 114 is of a sufficient density, stiffness, and applied insertion pressure that the member parts enable the creature to retain an upright and sitting position. This particular creature orientation is perceived by the user (e.g., a child) as reaching out to engage the user. Additionally, as is commonly-known in child rearing and child behavior (while not restricted for use by children, but available for teens and adults as well), outstretched arms typically convey a message of “hold me”, “pick me up”, and so on, thereby inviting the user to hold or cuddle the creature (product).

In describing other optional features of the product 100, a feature such as a compartment system 116 can be formed (constructed) into a member part (e.g., main body) and can be capable of receiving an item (not shown). The compartment system 116 is intended to mean a covered enclosure in which the item is placed. The compartment system 116 can be constructed into the main body 104 with or without a compartment cover 118. The item(s) can be any object the user chooses to place (e.g., store) in the compartment (not visible) of the compartment system 116, such as play items, food items, clothing items, and so on.

It is to be understood that in the disclosed product, certain features may be rearranged, combined, and omitted, and additional features may be included.

For example, alternatively, it is to be understood that the compartment system 116 can be made to be located as a single compartments system as part of the creature mouth or be a second compartment system located as part of the creature mouth in addition to the compartment system in the main body. Thus, the compartment of the compartment system would be recessed into the mouth/jaw parts and closed/opened via a closure mechanism such as a zipper, magnets, hook-and-loop technology, etc.

The compartment system 116 can also include the compartment cover 118 attached to the compartment system 116 to capture (e.g., enclose) the item and enable access to the item. The compartment in which an item can be placed can be recessed into the main body 104 so that the open (or access) side of the compartment is approximately flush with the product cover 110 of the main body 104 at that compartment location. The compartment geometry can be cylindrical, rectangular, square, elliptical, etc., with the compartment cover 118 matching the compartment geometry of the access side in order to provide a mating fit of the rim of the compartment cover 118 to the rim of the compartment. The method of attachment or interface of the compartment cover 118 to the compartment system 116 can be via many different ways, including but not limited to, magnets, hook-and-loop technology (e.g., Velcro™), zippers, snaps, buttons, and so on.

Where the method of attachment (or interface) of the compartment cover 118 to the compartment 202 is magnetics, the compartment cover 118 employs a magnet attached thereto (e.g., along the rim) and that enables magnetic coupling to a magnet affixed to the compartment 202 (e.g., rim). In this implementation, the compartment cover 118 can be entirely removable by the user simply pulling the compartment cover 118 away from the compartment 202, and then replacing the compartment cover 118 when desired. The inside of the compartment 202 can be lined with any suitable material for the intended purpose, for example, cloth, water repellant fabric, a logo embossed material, uncovered plastic, and so on.

In this rendition of the product 100, the ends 121 of the bear limbs can be made substantially flat or rounded where the paws would normally be on an actual bear. This feature facilitates orienting the bear on all four ends in a normally walking orientation of a live bear, rather than a sitting-up orientation, as shown.

At least one of the member parts (e.g., a rear leg) can include a cup holder 120 constructed thereinto to receive a container 122 (e.g., drink, food, non-food, etc.) in a non-spill orientation. The holder 120 can comprise a clutching apparatus (not shown, but similar to a clam-shell design that “pinches” (applies friction to) the container 122 to restrict movement of the container 122 when the container 122 is placed into the holder 120). Here, there is provided a cup holder constructed in each rear leg of the bear to receive a drink container in a non-spill orientation, for example, when the bear is in the sitting-up orientation.

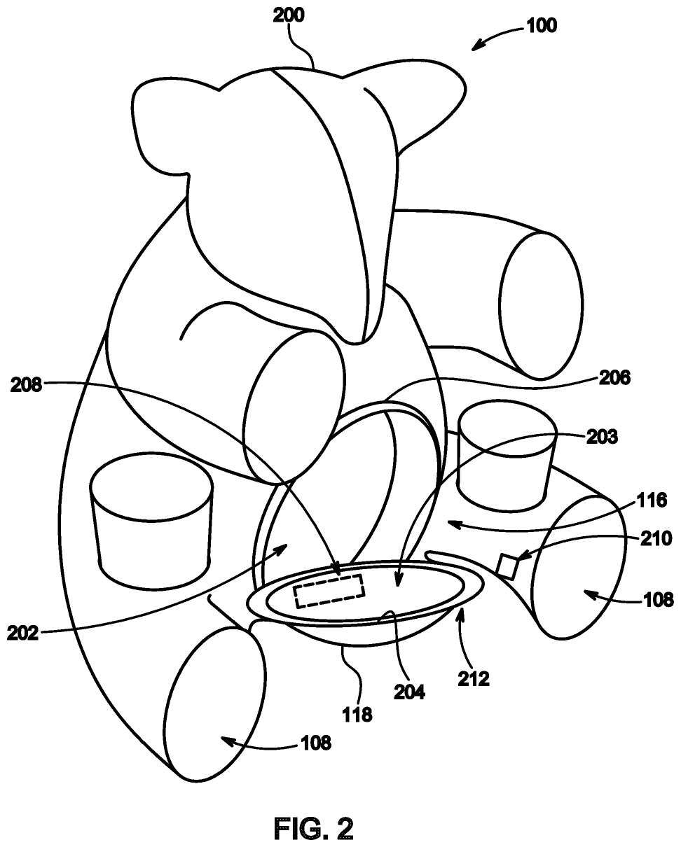

FIG. 2 illustrates the product 100 of FIG. 1 as a bear 200 with the compartment cover 118 in an open position. The compartment system 116 shows an exposed compartment (cavity) 202, and the compartment cover 118 in an open and substantially horizontal position as a platform on which an item (e.g., toy) or items (e.g., candy) can be placed and utilized. In another design, the compartment cover 118 can be a concave shape having an inwardly-curved surface 203 (of a typical bowl shape) that when the compartment cover 118 is open, the inwardly-curved surface 203 faces upward, and when closed, the inwardly-curved surface 203 faces the interior of the compartment 202.

In any case, compartment system 116 comprises a closure apparatus system (e.g., mating rims, cover/compartment surfaces, contact points, hinge or hinge-like item, etc.). The closure apparatus system includes a compartment cover closure apparatus 204 which is affixed to the rim of the compartment cover 118, and a compartment closure apparatus 206 which is part of (e.g., affixed) the perimeter of the compartment 202. Thus, the compartment cover 118 can include the compartment cover closure apparatus 204 which mates to the compartment closure apparatus 206 of the compartment 202.

The closure apparatus system can also be designed to include or function as a seal that when closed prevents unwanted effects (e.g., moisture, dust, etc.) from entering the compartment 202.

The closure apparatus system can further include hinged open/closure apparatus 208 (shown as a dashed-line box). Many different types of hinges can be employed. For example, a spring-loaded hinge having one part attached to the compartment 202 and the other part attached to compartment cover 118. When the compartment cover 118 is opened, the hinge holds the compartment cover 118 in the open position, and when closed the hinge holds the compartment cover 118 in the closed position.

In one implementation, a tensioned hinge can be utilized such that when the user opens the compartment cover 118 (which for the bear 200 opens in a pivoted downward position), the user applies a pulling force to overcome the design tension of the hinge. Once the tension is overcome, the compartment cover 118 automatically opens to a preset swing limit of the hinge such that the compartment cover 118 is in a horizontal orientation where an item placed on the upward face (interior face of the compartment cover 118) will not slide off.

In reverse, when the user then overcomes the hinge tension in an upward lifting motion of the compartment cover 118 to close the compartment cover 118, the tensioned hinge operates to automatically close the compartment cover 118 so that the closure apparatus of the compartment cover 118 and compartment 202 mate in alignment to provide a seal that prevents foreign material from entering the compartment system 116.

In another alternative implementation, when the compartment cover 118 is in the open position, the compartment cover 118 can be captured (e.g., temporally attached by hook-and-loop material such as VELCRO) in a suitable position (e.g., the compartment cover in relatively horizontal to hold liquid, solids, toys, etc.) by the rear legs 108 of the bear 200 to provide additional stability for using the compartment cover 118 as a platform, bowl, etc. More specifically, this alternative implementation can employ strategically placed hook-and-loop attachment parts 210: the attachment parts 210 on inside areas of the rear legs 108 can be connected to (mate) attachment parts 212 on the compartment cover 118.

For example, the attachment parts 210 can include short tethers (or straps) which can be designed to reach from the legs 108 to the compartment cover 118 to further provide stability of the compartment cover 118 when in the open position. The attachment parts 210 can be applied to the desired locations of the bear 200 for convenient user access, for example, where the legs 108 normally contact the compartment cover 118 when the compartment cover 118 is in the open position.

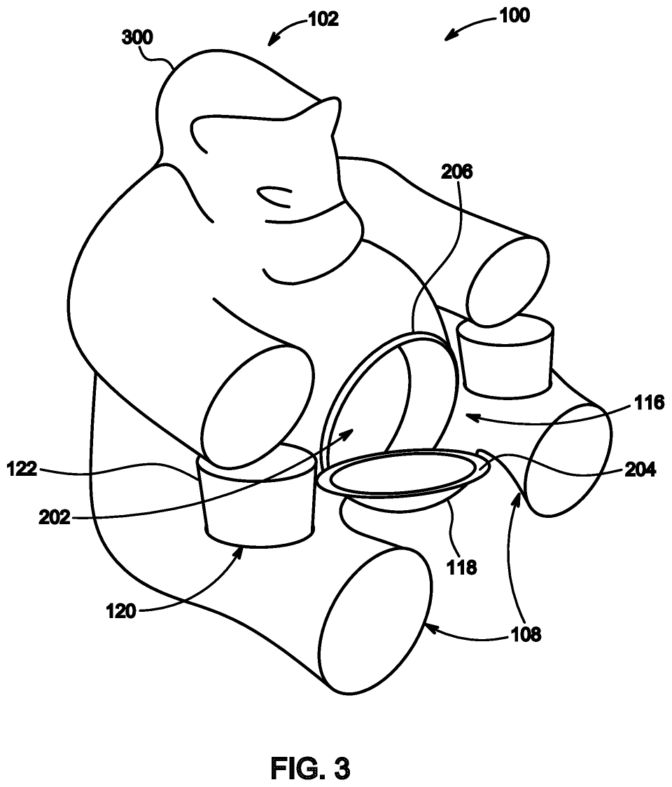

FIG. 3 illustrates the product 100 of FIG. 1 as a primate 300 (e.g., gorilla). The primate 300 can incorporate the same features and capabilities as the bear 200 of FIG. 2, with the exception that the head 102 is that of a primate (e.g., gorilla, chimpanzee, etc.). The primate 300 is shown in an upright sitting position with arms and legs extended forward in a substantially horizontal orientation and with the compartment cover 118 in an open position. This overall primate 300 orientation is the same as shown for the product 100 of FIG. 1 and the bear 200 of FIG. 2.

The compartment system 116 shows the exposed compartment (cavity) 202, and the compartment cover 118 in an open and substantially horizontal position as a platform on which an item (e.g., toy, food, etc.) or items (e.g., candy) can be placed. In another design, the compartment cover 118 can be a concave shape having an inwardly-curved surface (of a typical bowl shape) on the interior surface that when the compartment cover 118 is open, the inwardly-curved surface faces upward, and when closed, the inwardly-curved surface faces the compartment 202.

Other notable features similar to those of the product 100 of FIG. 1, include that the primate 300 can be a soft product which is encased in a flexible and resilient cover of material and/or fabric. The primate 300 serves as a huggable and cuddly article for the user (e.g., from child to adult). The user can grasp the primate 300 in its original non-deformed state, then squeeze, embrace, etc., the primate 300 to a temporarily deformed state, and once released, the primate 300 returns to the original non-deformed state.

The shape is intended to mimic zero, some, or all the features and appearance of what is commonly-known to be associated with the human or animal. At a minimum and as described herein, the creature will have member parts of at least the head and the main body.

Features of the primate 300 include, but are not limited to, the member parts shown for the bear 200 of FIG. 2, such as the head 102 and main body 104, as well as limbs such as front legs 106 and rear (or hind) legs 108.

Additional and/or other more detailed features can be added to primate 300; however, this is not a requirement, but an enhancement. For example, the head 102 can further include member parts of eyes, ears, and mouth (none of which are shown), and the main body 104 can further include a tail (not shown).

The primate 300 can comprise the details associated with the product 100 of FIG. 1, such as the product cover 110 fabricated into the shape of the creature and member parts of the creature. The product cover 110 can include one or more seams 112 where the various parts of the product cover 110 are joined (e.g., stitched, glued, using fasteners, etc.) together into the overall shape of the creature.

The fabricated product cover 110 can be made of any material suitable for the given application. For example, where the primate 300 is intended to be used in dry environments (e.g., home) away from water areas such as ponds, pools, bath tubs, etc., to mitigate semi-submersion and full submersion the product cover 110 can be a durable canvas fabric, polyesters, acrylic coated polyesters, nylon, cotton outer layer, and so on. A water-resistant fabric or coating material can also be utilized to mitigate sustained wetness on the cuddly creature by repelling moisture and any form of wetness in dry and wet environments.

The product cover 110 can be stuffed with the stuffing material 114 that is designed to hold the shape (original) of the primate 300 and the member parts. Thus, the stuffing material 114 can incorporate suitable stiffness (firmness), and when inserted into the member parts of product cover 110 according to a predetermined stuffing insertion parameter(s), enables the member parts to hold shape and orientation under most instances of user interaction. That is, “holding shape” is intended to mean that member parts such as the limbs maintain orientation as shown and provided at the time purchase, throughout extended use of the primate 300 over time.

The stuffing material 114 can include any material suitably designed/available to provide the desired product orientation effects for upright use and limb orientations, such as closed-cell foam cushion, unicellular polyurethane foam, and more resilient foam and materials that invite an appealing, cuddly, and squeezable user interaction.

As described in FIG. 1, the stuffing material 114 is of a sufficient density, stiffness, and applied insertion (stuffing) pressure that the member parts enable the creature to obtain and retain the desired use parameters, such as an upright position, crawling position, and a sitting position. This particular creature orientation is perceived by the user (e.g., a child) as reaching out to engage the user. Additionally, as is commonly-known in child rearing and child behavior (while not restricted for use by children, but available for teens and adults as well), outstretched arms typically convey a message of “hold me”, “pick me up”, and so on, thereby inviting the user to hold or cuddle the creature (product).

In describing other optional features of the primate 300, the compartment system 116 can be formed (constructed as recessed) into the main body 104 and can be capable of receiving an item (not shown). As before, the compartment system 116 is intended to mean a covered enclosure in which the item is placed and which can be accessed by moving the compartment cover. The compartment system 116 can be constructed in the main body 104 with or without a compartment cover 118. The item(s) can be any object the user chooses to place (e.g., store) in the compartment 202 of the compartment system 116, such as play items, food items, clothing items, and so on.

The compartment system 116 can also include the compartment cover 118 attached to the compartment framework to capture (e.g., enclose) the item and enable access to the item. The method of attachment or interface of the compartment cover 118 to the compartment 202 can be via many different ways, including but not limited to, magnetics, hook-and-loop technology (e.g., Velcro™), zippers, snaps, buttons, and so on.

As described in FIG. 2 for the compartment system 116, where the method of attachment (or interface) of the compartment cover 118 to the compartment 202 is magnetics, the compartment cover 118 employs a magnet attached thereto (e.g., along the rim) and that enables magnetic coupling to a magnet affixed to the compartment 202 (e.g., rim). In this implementation, the compartment cover 118 can be entirely removable by the user simply pulling the compartment cover 118 away from the compartment 202, and then replacing the compartment cover 118 when desired. The inside of the compartment 202 can be lined with any suitable material for the intended purpose, for example, cloth, water repellant fabric, a logo embossed material, uncovered plastic, and so on.

In this rendition of the primate 300, the ends of the primate limbs can be made substantially flat or rounded where the hands and rear feet would normally be on an actual primate. This feature facilitates orienting the primate 300 on all four ends, rather than a sitting-up orientation, as shown.

At least one of the member parts (e.g., a rear leg) can include the cup holder 120 constructed thereinto to receive the drink container 122 in a non-spill orientation. Here, there is provided the cup holder 120 constructed into each rear leg 108 of the primate to receive the drink container 122 in the non-spill orientation, when the primate 300 is in the sitting-up orientation, as shown.

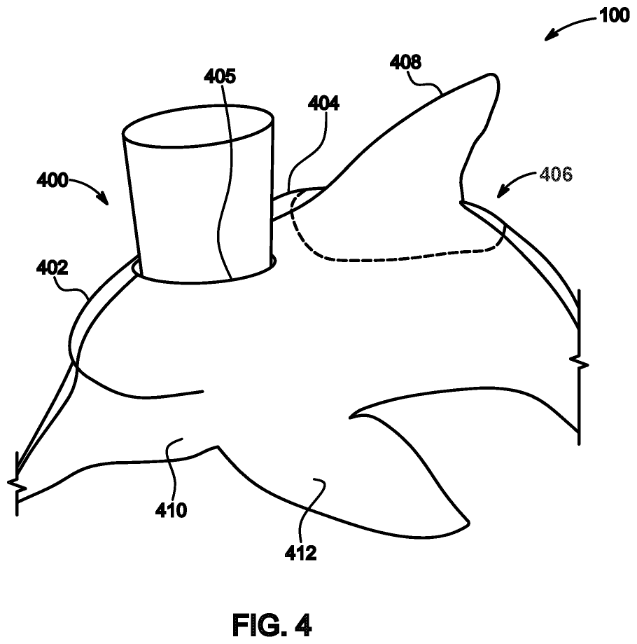

FIG. 4 illustrates the product 100 as a marine animal 400 (e.g., a dolphin, shark, squid, octopus, coral, etc.). Here, the marine animal 400 includes member parts of at least a head 402 and main body 404. The head 402 includes a holder 405 (e.g., similar to the cup holder 120) that accommodates a container (e.g., the drink container 122, soup, etc.). The main body 404 further includes a member part as a dorsal fin. The dorsal fin includes a compartment system 406 for storing an item, if desired, and enclosing the item. The compartment system 406 can be comprised of a compartment cover and internal compartment (cavity) (not visible). As depicted, the compartment cover can be in the shape of the dorsal fin 408 of the marine animal 400.

Alternatively, the compartment cover is underneath and separate from the dorsal fin 408. Thus, the dorsal fin 408 opens to expose the compartment cover, under which is the compartment. The compartment cover and/or dorsal fin 408 can be attached to the main body 404 in several different ways, as described above with the bear 200 and the primate 400. Where the dorsal fin 408 is the compartment cover, the dorsal fin 408 can be attached to the main body 404 using an attachment mechanism as a zipper, magnets, hook-and-loop material, and other techniques described herein.

As described in FIG. 1, the marine animal 400 incorporates stuffing material 410 (similar to stuffing material 114) of a sufficient density, stiffness, and applied insertion (stuffing) pressure that the member parts (e.g., head 402, main body 404, one or more fins, e.g., dorsal fin 408) enable the marine animal 400 to retain a horizontal swimming or resting orientation. It can also be the case that the stuffing material 410 surrounds an internal flexible yet stiff wire frame such that the limbs can be bent to a specific orientation and will then hold this orientation based on the wire frame. The user can then bend this limb back to the previous orientation or to a new orientation. This particular creature orientation provides support stability for the container in the holder, and upward orientation for the compartment when the compartment cover 408 is opened to expose the compartment. The wire frame can be employed in all products described herein.

The marine animal 400 also comprises two additional member parts as pectoral fins 412 (of which only one is visible), which provide overall stability of the marine animal 400 when placed on a flat surface such as a floor or table. Although not shown here, the marine animal 400 can also include a tail fin common to many different kinds of cold and warm-blooded marine creatures such as fish, sharks, etc.

Where the marine animal 400 is the dolphin, the “breathing hole or blowhole” of the dolphin is fitted to accommodate the holder 405, and the dorsal fin 408 can be removed or folded back to expose the compartment that holds one or more items such as a food product and/or small non-consumable item (e.g., a ball, gift, basket, etc.).

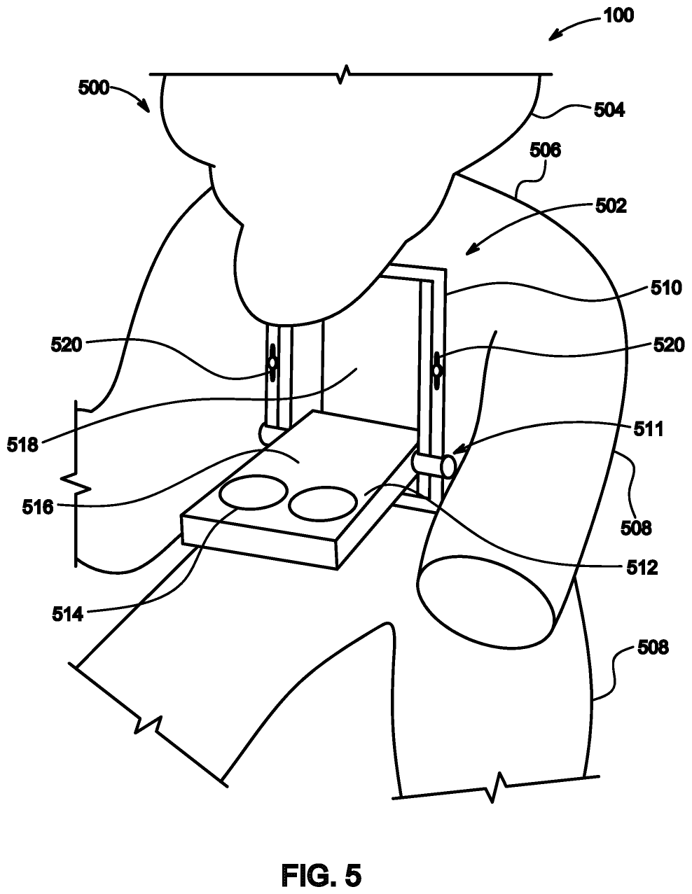

FIG. 5 illustrates the product 100 as a creature 500 that includes a flip-down tray system 502. The creature 500 closely resembles the bear 200 of FIG. 2 and the primate 300 of FIG. 3, in several ways, and yet may be a koala bear. All are creatures having a head, main body, and four limbs, and each are designed to be deployed in a predominantly upright position with limbs (arms and legs) extended forward horizontally. The creature 500 has member parts of a head 504, main body 506, and four limbs 508, where the limbs 508 are extended forward horizontally.

The tray system 502 includes a housing frame 510 and a flip-down tray 512. The flip-down tray 512 further includes at least one cup holder 514 and a surface 516 on which items (e.g., treats, food, toys, etc.) can be placed. The flip-down tray 512 can be hingedly attached to the housing frame 510 via a hinge mechanism 511. Thus, in an open position, the flip-down tray 512 opens to a substantially horizontal orientation so that the surface 516 is also horizontal. In one example implementation, the tray 512 swings through a maximum angle of ninety degrees between the open and closed positions.

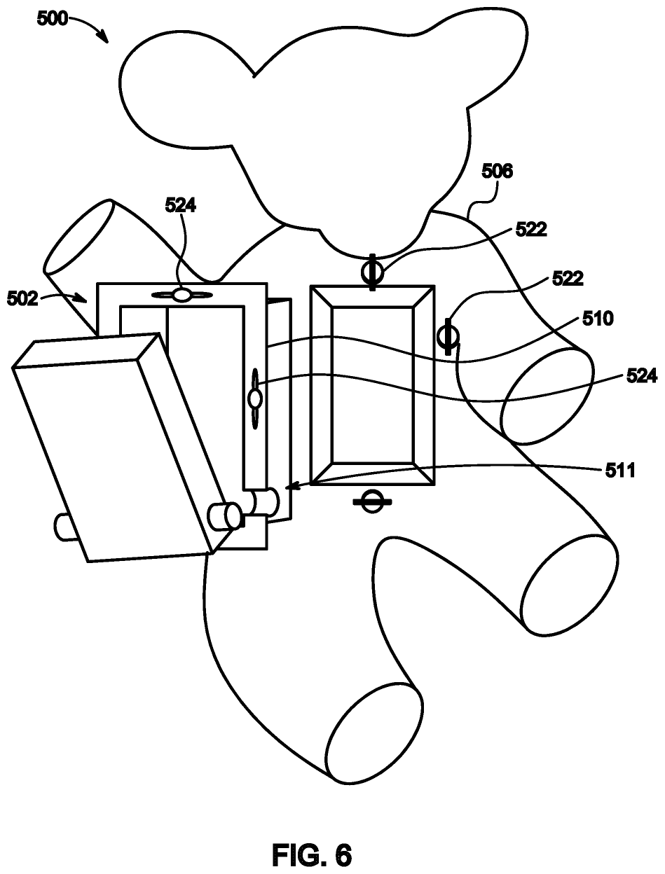

The housing frame 510 includes a recessed portion 518 into which the tray 512 swings closed to a stored position. The tray 512 can then be latched into the recessed portion 518 to be secure during handling, for example. The recessed portion 518 is then designed to be similarly constructed into a cover recessed portion as shown in FIG. 6. Thus, the tray system 502 is conveniently out of the way when in the closed and secured position.

The housing frame 510 can be attached to the front part of the main body 506 by way of a quick release-attachment mechanism 520. The quick release-attachment mechanism 520 can be any suitable mechanism that facilitates easy release and attachment of the tray system 502 (e.g., hook-and-loop, magnetics, etc.).

In one implementation, the quick release-attachment mechanism 520 comprises quarter turn buttons 522 (fasteners, latches, etc.) (e.g., four each, one button on each side of the housing frame 510) that insert through mating slots 524 of the housing frame 510. Thus, when turned in one way, the quarter turn buttons secure the housing frame 510 to the main body 506, and when turned the other way, the quarter turn buttons release the housing frame 510 from the main body 506. In this implementation, the quarter turn buttons, for example, are fabricated into the product cover 110 on the creature 500 and the mating slots 524 that receive the buttons 522 incorporated into the perimeter of the housing frame 510.

FIG. 6 illustrates the creature 500 of FIG. 5, where the tray system 502 is removable. The tray system 502 can be removed from and replaced back into, the main body 506. Additionally, here, the flip-down tray 512 can be detached from the housing frame 510, as well, via the hinge mechanism 511. The hinge mechanism 511 operates to couple the tray 512 to the housing frame 510 in a pivotal way while also capturing the tray 512 to the frame 510 when in the closed position so the tray does not fall out of the frame 510 when the tray 512 is not in use.

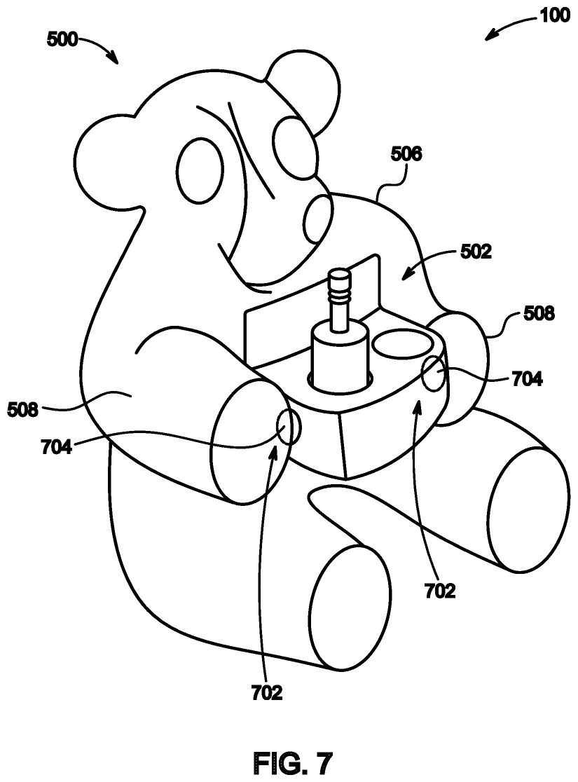

FIG. 7 illustrates the creature 500 of FIG. 5, where the tray system 502 is captured and stabilized by the creature arms. The tray system 502 can be removed entirely from the main body 506 and supported solely by contact with limbs 508 (e.g., arms, legs), and front of the main body 506 using any suitable contact material on the corresponding body members such as hook-and-loop tape or patches.

In this example, the interior sides of the arms 702 includes one part (e.g., a hook patch) of a two-part hook-and-loop attachment mechanism 704, and the tray system 502 includes corresponding second parts such as loop parts of the hook-and-loop attachment mechanism 704. Thus, the user can position the tray system 502 and press the arms inward so that the parts of the attachment mechanism 704 engage to capture and stabilize the tray system 502 for use. Compatible length adjustable hook-and-loop tethers can also be employed from the limbs 508 to the tray system 502.

The number and locations of attachment points of the attachment mechanisms can be several, limited only by the design of the creature 500 (and the other creatures described herein). For example, one or more attachment points can be on the chest and/or lower main body areas of the creature 500 with mating attachment part(s) on the back of the tray system 502.

Put another way, the disclosed products can be soft products in shapes of various creatures. A product can comprise a product cover fabricated into the shape of the creature and member parts of the creature, the product cover stuffed with stuffing material to hold the shape of the creature and the member parts in a predetermined orientation. The product can further comprise a compartment system formed into a member part and capable of receiving an item, the compartment system comprising a compartment into which the item is placed and a compartment cover that mates to the compartment to capture the item in the compartment and enable access to the item.

The creature can be a primate, and the product cover can be formed into the shape of the primate and associated primate member parts, the primate member parts include at least one of a head, main body, arms, or legs. The main body can further comprise the compartment and compartment cover. The compartment cover opens and remains in a horizontal position. The compartment cover closes on the compartment and remains closed based on a mechanical closure apparatus. At least one of the compartment or the compartment cover are removable from the product.

The compartment cover is hinged to the compartment and opens downward into a horizontal position to expose a flat surface in a horizontal plane on which the item can be placed, the compartment cover comprising a cup holder for holding a drink container in an upright orientation to prevent spillage.

The compartment and compartment cover serve as a tray system formed into a member part. The creature can be a bear, and the product cover is formed into the shape of the bear and associated bear member parts. The bear member parts include at least one of a head, main body, legs, or arms, the main body further comprises the compartment and compartment cover, the at least one of the bear member parts includes a cup holder constructed thereinto to receive a drink container in a non-spill orientation.

The creature can be a marine animal, and the product cover is formed into the shape of the marine animal and associated marine animal member parts, the marine animal member parts include at least one of a head, main body, or at least a fin. The compartment system is formed into the main body of the marine animal and under a fin, the fin includes the compartment cover and opens to expose the compartment in which nutrition can be stored and from which the nutrition can be accessed and consumed.

The marine animal further comprises a cup holder as part of the head, the cup holder constructed thereinto to receive a drink container in a non-spill orientation. The compartment and compartment cover serve as a standalone unit that can be removed from the product and captured in a stable manner by at least two member parts of the creature for access to the item.

Put in yet another way, a soft product in a shape of a creature is disclosed, comprising a product cover fabricated into the shape of the creature and member parts of the creature, the member parts include at least a head and a main body, the product cover stuffed with stuffing material to maintain the shape of the creature, maintain orientation of the creature, and maintain orientation of the member parts relative to the main body; and a compartment and a compartment cover formed into the main body member part, through the product cover, and capable of receiving an item, the compartment cover attached to the compartment to enclose the item in the compartment for storage and enable access to the item when open, the compartment and compartment cover removable from main body for use as a standalone unit.

Electromechanical Subsystem for Soft Products

Products in today's manufacturing can be made suitable and compatible for electronics subsystems to perform and provide features for any desired purpose. The disclosed soft products are such items that when enhanced with such electronics and mechanical subsystems (together referred to as “electromechanical”) can offer surprising functions, features, and interactions for the user and user systems.

Such product electronic subsystems include, but are not limited to, standalone audio and/or video subsystems constructed into the soft product, one-way push communications from an external device to the electronics subsystem(s) of the soft product, two-way communications between the external device and the internal electronics subsystem(s) of the soft product which enable the play of audio/video data and command/control capability of the soft product subsystems, standard wire and wireless network technologies and interfaces, mesh network and communications technology where multiple soft products inter-communicate for a specific purpose such a network extension and access points, near-field communications (NFC) subsystems including Bluetooth™, RFID (radio frequency identification), etc., for device/soft product subsystem communications, and so on.

The electromechanical subsystem (ES) is provided with capabilities that enable the user to launch an application to interact with features provided. For example, the soft product can be designed and sold with a compatible user interface application which can be installed onto a smart phone and other suitable computing devices (e.g., tablet, portable computer, desktop computer, etc.). The user can than launch the application to access capabilities of the ES of the soft product to view current settings, capabilities, status of systems and sensors, and so on.

For example, the user can access a setting of the ES which enables the user to record voice on the soft product for playback according to certain parameters such as a specific time, in response to a specific and identified user, in response to sensor data received from one or more sensors installed on the soft product and connected to the ES, based on multiple sensor data received and processed by the ES, and so on. For example, if a temperature sensor senses that the ambient temperature proximate the soft product is trending up at an alarming rate, a warning notification can be played to the space in which the soft product is located.

Alternatively, or in addition to, the notification can be transmitted from the soft product to a user device, nearby (e.g., in the house, or location) or remote therefrom (e.g., to a cell phone of the user who is many miles away). Still further, the notification can be selected by a setting to be transmitted from the soft product to emergency services such as police, medical, and/or fire department.

In yet another enhanced capability, the soft product located with or nearby to a child, can process child speech and voice signals to determine if to transmit a notification to a parent, baby sitter, etc. located within a residence, and/or transmit the notification to a parent (e.g., via a smart phone of the parent) currently away from the residence.

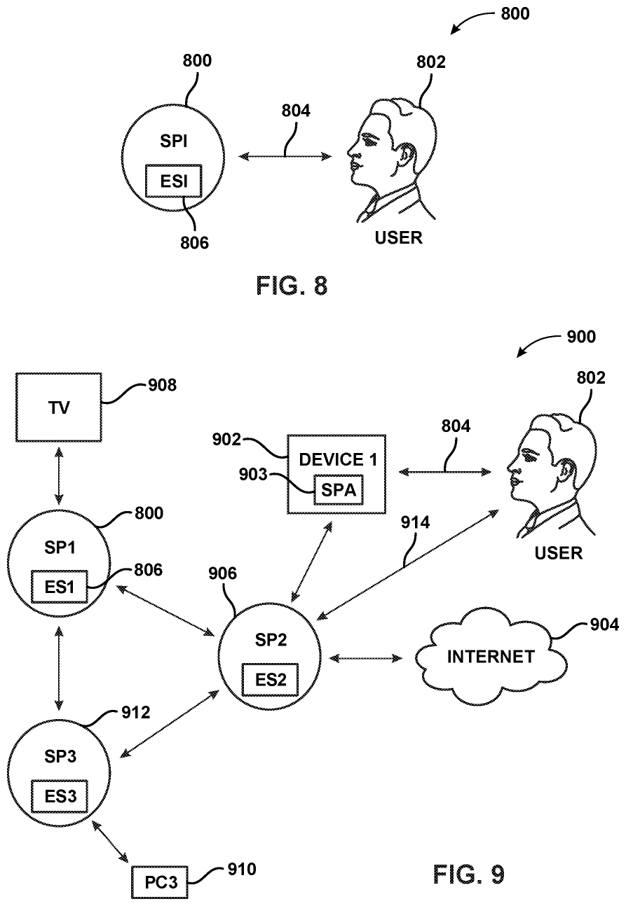

FIG. 8 illustrates a soft product 800 in accordance with the disclosed architecture that can incorporate electromechanical capabilities and features as described herein.

As described and used herein, an appendage is defined to be any subsidiary part that extends from a more central or principal structure or part. For example, a head of a creature (e.g., human, primate, sea, flying, etc.) can be considered an appendage to the abdomen or central body thereof. Moreover, an ear can be an appendage of the head. All limbs are considered appendages to the abdomen or central body. This is similar for creatures such as primates and all terrestrial animals, birds, and insects, as examples. Sea creatures such as fish and ocean dwelling mammals, crustaceans, coral, cephalopods, and so on, also have appendages. A dolphin, for example, has the appendages to the main or central body of fins such as a dorsal fin, pectoral fins, and tail fins (referred to as flukes).

As depicted in FIG. 8, a user 802 interacts 804 with the soft product (SP1) 800. The soft product 800 as described herein can be formed as a creature such as a primate, bear, and/or dolphin, for example. The interaction 804 can be in many different ways. The interaction 804 can be the user 802 physically contacting the soft product 800 to engage the electromechanical subsystem (ES1) 806 to power on or power off the ES1 806 by engaging a power switch.

In another embodiment, the ES1 806 employs voice recognition technology such that the interaction 804 is by the user 802 voicing a command or commands that when processed by the ES1 806 changes the power state of the soft product 800 from a sleep (minimal power) mode to a full-power mode. Thus, in this embodiment, the soft product 800 remains powered at a minimal power level to process incoming vocal signals until such time a specific command or commands to power on is received from the user 802 and recognized by the ES1 806. In a similar way, a specific command or commands to power off (or enter sleep mode or some minimum power level that continues to receive and process vocal command or signals) can be voiced from the user 802 to the soft product 800, in response to which the ES1 806 changes the power state from full power mode to the sleep (or minimum) mode power level, or powers off the ES1 806 entirely. When powered off entirely, the user 802 will then physically engage the power switch to power on the soft product 800.

In another embodiment, the interaction 804 can be based on image recognition technology. In one example, gesture recognition is supported such that hand/finger/arm/eye/facial movements, for example, are captured (via a camera system), image recognized, and processed by the ES1 806 to effect specific actions of the ES1 806 for perception (e.g., audio, video, data, etc.) by the user 802. One such gesture can be processed to raise or lower the volume of audio output of the product 800 by raising a hand or lowering the hand in a specific way.

Gestures can be programmed into the ES1 806 by the user 802 for a customized user gesture experience, and/or be received with a basic set of gestures stored therein when purchased. Thereafter, the user 802 can add to the basic set of gestures by programming customized gestures into the ES1 806. Similarly, the ES1 806 can be designed to enable user input customization of voice commands to then perform specific actions when the user 802 voices one or more of these commands.

In yet another embodiment, voice (speech) and image recognition of the ES1 806 are processed in combination to effect audio output to the user 802 when a gesture is unrecognized. Thus, an output audio response can be similar to “gesture not recognized—please repeat the gesture”, as an example. Similarly, where the ES1 806 is connected to a driving a display (e.g., onboard display, external display, TV, display of another device such as a cell phone, tablet, etc.), a message can be generated and presented on such display(s) to alert the user 802.

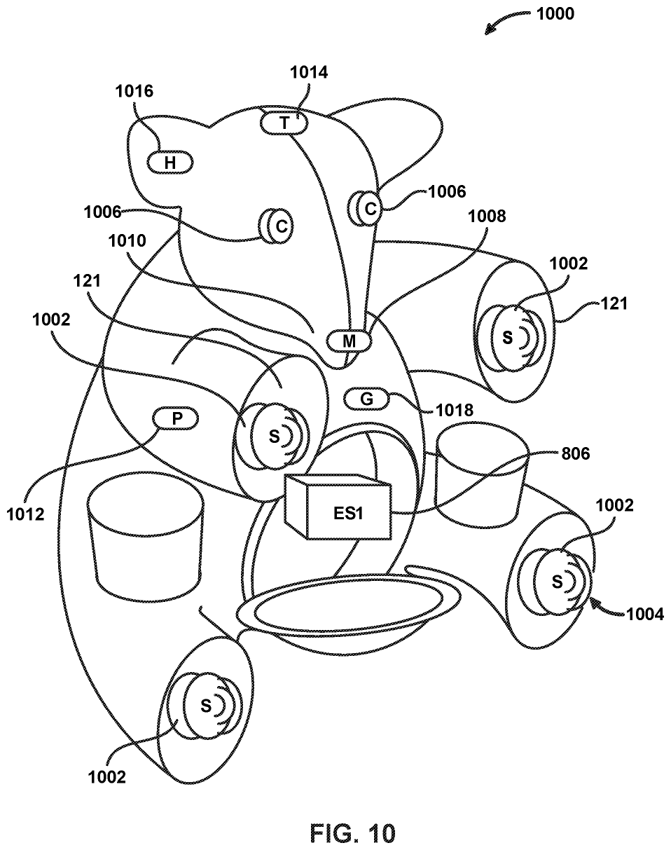

FIG. 9 illustrates a soft product mesh network 900 capability, in accordance with the disclosed architecture that incorporates electromechanical capabilities and features as described herein. In this embodiment, the electromechanical subsystem, ESx (where x is 1, 2, 3, . . . ), also includes networking capabilities, and more specifically, mesh network and standard networking capabilities. Thus, where the user 802 has several soft products SPx (where x is 1, 2, 3, . . . ), dispersed throughout a space (e.g., rooms of a house, office, etc.), each soft product SPx can provide network access to a private network in the space and/or Internet access as well.

In one example, the user 802 uses (interaction 804 with) a handheld device 902 (e.g., smart phone, cell phone, tablet, any portable device employing connectivity and computing subsystems, TV, etc.) to communicate data and/or signals to the Internet 904 via a soft product (SP2) 906, a local or remote device 908 such as a television (TV), a personal computer (PC3) 910, and/or other soft products SPx (such as product SP1 800 and product (SP3) 912 similarly equipped.

A soft product (e.g., 800, 906 and 912) can be sold as an enhanced product which includes an ES, and a soft product application (SPA) 903 for interfacing to and controlling hardware and software features of the ES in the given soft product.

The user 802 can interact 804 with the device 902 to cause any one or more of the three soft products (SP1, SP2, SP3) to react in a certain way. For example, the user 802 can speak into the device 902, which gets transmitted to designated SPx (e.g., soft product 906), processed there, and then output via an audio output device of the soft product 906 to a nearby listener (e.g., child, adult, other voice activated and responsive device that can interact with a network (e.g., Xbox™, Alexa™ by Amazon Company, Echo′ by Amazon Company, other similar smart devices/systems, etc.)).

In another example, the speech input to the device 902 can be broadcast to all soft products (800, 906 and 912) for output to all spaces in which these products are located. Similarly, rather than the user speech (audio), video can be transmitted from the device 902 to zero, some, or all of the soft products (800, 906, and 912) for presentation via a display of a given soft product (e.g., soft product 912).

In another example, the user 802 can cause media (audio and/or video and/or content) to be retrieved from the Internet 904 and played on one or more of the soft products (800, 906, 912), the TV 908, PC3 910, and/or device 902. In yet another example, the user 802 (via interaction 804) can cause to occur (via the device 902) the transmission and play of media from one soft product 912 to another soft product 800.

In other examples, the user 802 can interact directly with soft product 906 via interaction 914 and cause to be processed and effected some or all of the actions described herein when using device 902.

FIG. 10 illustrates a soft product system 1000 with the soft product 800 creature as the bear 200 in a “seated” upright position and “foot” (paw) bottoms (also referred to hereinabove as ends 121 of the bear limbs) facing away from the abdomen, in accordance with the disclosed architecture that incorporates electromechanical capabilities and features as described herein.

In this implementation, the electromechanical system (ES1) 806 can employ audio speakers 1002 just inside the ends 121 of the limbs (the front legs 106 and hind legs 108) and situated internally so that audio output from the speakers 1002 is not prohibitively impeded, but provides a suitable and sufficient output for the average listening user. Thus, audio output signals 1004 will likely be directed forward (projected) to the user and/or into the space in which the soft product 800 (bear 200) is located.

The electromechanical subsystem (ES1) 806 is represented as the block extended outward from the compartment 202 for easier viewing, and can be made accessible through the compartment 202. Alternatively, the ES1 806 can be made accessible through an access door (not visible) in the back of the soft product 800. The ES1 806 block incorporates all wired and/or wireless connections between all input and output (I/O) sensors such as a microphone, standard hardware ports/connectors (e.g., USB, Ethernet, micro-USB, etc.) for interfacing a wide variety of hardware products (e.g., flash drives, memory cards, etc.) commonly accessible in the marketplace. The ES1 806 also incorporates the software needed, processor(s), and data storage components for operation of all electromechanical components (e.g., processors, hardware switches, connectors, etc.).

The ES1 806 can also include “eyes” 1006 which enable camera (C) access to external views, and therefore, images for at least gesture recognition and facial recognition, for example. There can be incorporated into the ES1 806 one camera (in one eye 1006) or two cameras (one camera in each eye 1006), or other suitable location such as above the compartment system 116.

A microphone (M) 1008 can be located in a nose 1010 of the bear 200 to receive audio input signals from user speech, and/or other audio sources, for example, such as pets, children, televisions, radios, telephones, and so on.

Although not depicted, the ES1 806 can include many other types of sensors such as tilt sensor(s) to track orientation (e.g., horizontal, vertical, yaw, etc.) of the soft product 800, pressure (P) sensors 1012 (e.g., in a limb) to sense squeeze pressure, for example, applied to the limb(s) 121, temperature (T) sensor(s) 1014 to sense temperature data of the product 800 and/or surrounding environment, humidity (H) sensor(s) 1016 to sense humidity data, a geolocation (G) sensor 1018 to track the geographic location (e.g., GPS (global positioning system)) of the soft product 800, and so on. These other sensors can be located in the ES1 806 block and/or member parts of the soft product 800.

The ES1 806 can be programmed to monitor the temperature data as received by the temperature sensor (e.g., sensor 1014) to trigger detection of a fire, and in response, contact emergency services to the location of the soft product 800. More broadly, the ES1 806 comprises hardware and software components to enable a broad spectrum of data and signals to be processed, stored, analyzed on and for the soft product 800 or remotely (e.g., “in the cloud”). Thus, user behavior and characteristics can be observed regardless of the age of the user.

In one implementation, a soft product is disclosed and described herein, comprising: a product cover fabricated into the shape of a creature and member parts of the creature, the member parts include a main body and an appendage of the main body; a compartment system formed into the main body, the compartment system comprising a compartment into which an item can be placed and a compartment cover that mates to the compartment to enable access to the item; a holder constructed into a member part, the member part at least one of the head or other appendage; and an electromechanical subsystem located inside the soft product, and for processing at least one of audio, video, or communications signals.

The electromechanical subsystem is accessible via the compartment system. The electromechanical subsystem includes an audio output component constructed into a member part to output audio signals. The electromechanical subsystem includes an audio input component constructed into a member part to receive audio signals. The electromechanical subsystem includes a transceiver system that enables transmission and reception of the audio, video, and communications signals. The electromechanical subsystem includes at least one of an audio or video player subsystem for processing and playing audio and video data for presentation to a user.

The electromechanical subsystem includes at least one port for receiving a data device from which to access and play at least one of audio or video data. The electromechanical subsystem includes at least one network port via which at least one of wired or wireless network communication is enabled. The electromechanical subsystem enables wireless communication with at least one of a cellular-capable or non-cellular device from which to receive and play at least one of audio, data, or video signals, and to which to transmit at least one of audio, data, or video signals.

The electromechanical subsystem includes a mesh network node capability that functions as a mesh node in a mesh network. The electromechanical subsystem includes a display which enables the presentation of video signals. The electromechanical subsystem includes a speech recognition subsystem for processing speech signals from a user and outputting an audio signal to the user. The electromechanical subsystem includes a data storage subsystem that enables the storage of software data, software data updates, and user-supplied data. The electromechanical subsystem includes electromechanical components in the member parts that are controlled by a microprocessor to activate in a specific way in response to at least one of speech or a gesture communicated from the user to the soft product.

In another implementation, a soft product is disclosed and described herein, comprising: a product cover fabricated into the shape of a creature and member parts of the creature, the member parts include a main body and an appendage of the main body; a compartment system formed into the main body, the compartment system comprising a compartment into which an item can be placed and a compartment cover that mates to the compartment to enable access to the item; a holder constructed into a member part, the member part at least one of the head or other appendage; and an electromechanical subsystem located inside the soft product, and for processing at least one of audio, video, or communications signals.

The electromechanical subsystem includes: an audio output component constructed into a member part to output audio signals; a transceiver system that enables transmission and reception of the audio, video, and communications signals; at least one of an audio or video player subsystem for playing audio and video data for presentation to a user; at least one port for receiving a data device from which to access and play at least one of audio or video data; and a data storage subsystem that enables the storage of software programs and data, software program and data updates, and, user-supplied program and data inputs.

The electromechanical subsystem is accessible via the compartment system. The electromechanical subsystem includes an audio input component constructed into a member part to receive audio signals. The electromechanical subsystem includes at least one network port via which at least one of wired or wireless network communication is enabled. The electromechanical subsystem enables wireless communication with at least one of a cellular-capable or non-cellular device from which to receive and play at least one of audio, data, or video signals, and to which to transmit at least one of audio, data, or video signals.

In yet another implementation, a soft product is disclosed and described herein, comprising: a product cover fabricated into the shape of a creature and member parts of the creature, the member parts include a main body and an appendage of the main body; a compartment system formed into the main body, the compartment system comprising a compartment into which an item can be placed and a compartment cover that mates to the compartment to enable access to the item; a holder constructed into a member part, the member part at least one of the head or other appendage; and an electromechanical subsystem located inside the soft product, and for processing at least one of audio, video, or communications signals.

The electromechanical subsystem includes: a transceiver system that enables transmission and reception of the audio, video, and communications signals; a speech recognition subsystem for processing speech signals from a user and outputting an audio signal to the user; a video recognition subsystem for processing images received from a camera subsystem; electromechanical components in the member parts controlled by a microprocessor to activate in a specific way in response to at least one of speech or a gesture communicated from the user to the soft product; and a data storage subsystem that enables the storage of software programs and data, software program and data updates, and, user-supplied program and data inputs.

As used in this description, the terms “component” and “system” are intended to refer to a computer-related entity, either hardware, a combination of software and tangible hardware, software, or software in execution. For example, a component can be, but is not limited to, tangible components such as a microprocessor, chip memory, mass storage devices (e.g., optical drives, solid state drives, and/or magnetic storage media drives), and computers, and for software components such as a process running on a microprocessor, an object, an executable, a data structure (stored in a volatile or a non-volatile storage medium), a module, a thread of execution, and/or a program.

By way of illustration, both an application running on the ES and the ES can be a component. One or more components can reside within a process and/or thread of execution, and a component can be localized on one computer and/or distributed between two or more computers.

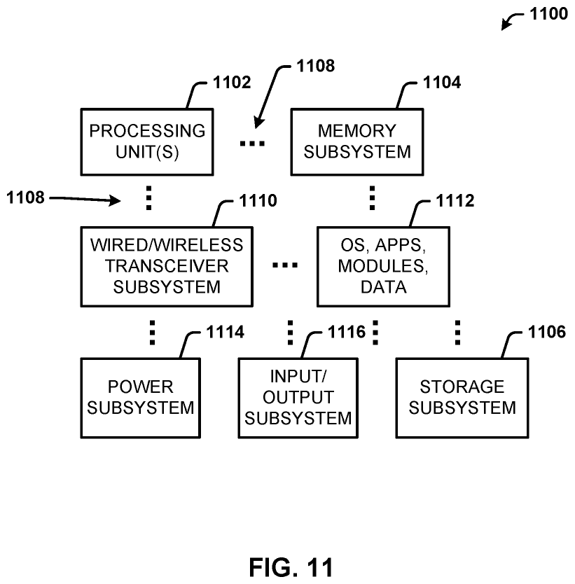

Referring now to FIG. 11, there is illustrated a block diagram of an electromechanical subsystem 1100 in accordance with the disclosed architecture. It is appreciated, however, that the some or all aspects of the disclosed methods and/or systems can be implemented as a system-on-a-chip, where analog, digital, mixed signals, and other functions are fabricated on a single chip substrate.

In order to provide additional context for various aspects thereof, FIG. 11 and the following description are intended to provide a brief, general description of the suitable ES 1100 in which the various aspects can be implemented. While the description above is in the general context of computer-executable instructions that can run on one or more computing systems, those skilled in the art will recognize that a novel implementation also can be realized in combination with other program modules and/or as a combination of hardware and software.

The ES system 1100 for implementing various aspects includes (micro)processing unit(s) 1102 (also referred to as microprocessor(s) and processor(s)), a memory subsystem 1104 comprising a computer-readable storage medium such as a system memory and a storage subsystem 1106 (computer readable storage medium/media also include magnetic disks, optical disks, solid state drives, external memory systems, and flash memory drives), and a bus system 1108 (denoted using ellipsis . . . ). The processing unit(s) 1102 can be any of various commercially available microprocessors such as single-processor, multi-processor, single-core units and multi-core units of processing and/or storage circuits.

The ES 1100 can be employed in support of cloud access and computing services. Cloud computing services, include, but are not limited to, infrastructure as a service, platform as a service, software as a service, storage as a service, desktop as a service, data as a service, security as a service, and APIs (application program interfaces) as a service, for example.

The memory subsystem 1104 can include computer-readable storage (physical storage) medium such as a volatile (VOL) memory (e.g., random access memory (RAM), static RAM for caching, etc.) and a non-volatile memory (NON-VOL) (e.g., ROM, EPROM, EEPROM, etc.), for example. A basic input/output system (BIOS) can be stored in the non-volatile memory, and includes the basic routines that facilitate the communication of data and signals between components within the ES 1100, such as during startup.

The bus system 1108 provides an interface for system components including, but not limited to, the memory subsystem 1104 to the processing unit(s) 1102, and any wire/metal track interconnectivity between all modules such as a wired/wireless transceiver subsystem 1110, operating system (OS) applications (Apps), software modules, and data components 1112, a power subsystem 1114 that provides power to all subsystems and components, and an I/O (input/output) subsystem 1116 which includes all sensors (e.g., microphone, temperature, humidity, geolocation, level, pressure, and so on) and the electronics to operate and return data therefrom. The bus system 1108 can be any of several types of commercially available bus architectures.

The power subsystem 1114 can comprise technologies such as solely a battery system (where the user replaces batteries when discharged below a minimum power level), solely a utility outlet power (e.g., the soft product can be plugged into grid voltage such as 120 VAC to charge onboard batteries and/or operate solely on grid power), an induction technology where the user simply places the soft product proximate an induction plate to couple charging power into the onboard battery subsystem, or any combination of these power technologies. The power subsystem 1114 can also receive power via a portable solar power system that can connect to the ES (e.g., via a USB connector) and power the ES subsystems of the soft product when away from grid power, such as at the beach or lake, for example.

The ES 1100 further includes machine readable storage subsystem(s) 1106 (and storage interface(s)) for interfacing the storage subsystem(s) 1106 to the bus system 1108, and other desired components and circuits. The storage subsystem(s) 1106 (physical storage media) can include one or more of a hard disk drive (HDD), a magnetic floppy disk drive (FDD), solid state drive (SSD), flash drives, and/or optical disk storage drive (e.g., a CD-ROM drive DVD drive), for example. The storage interface(s) included as part of the storage subsystem 1106 can include commonly available interface technologies such as EIDE, ATA, SATA, and IEEE 1394, for example.

Although shown as separate blocks, one or more application programs, program data, OS, and other software modules of block 1112 can be stored in the memory subsystem 1104, a machine readable and removable memory subsystem (e.g., flash drive form factor technology), and/or the storage subsystem(s) 1106 (e.g., optical, magnetic, solid state).

The operating system, one or more application programs, other program modules, and/or program data can include items and components of the ES1 806 of FIGS. 8-10, and, items and components of the system 900 of FIG. 9, for example.

Generally, programs include routines, methods, data structures, other software components, etc., that perform particular tasks, functions, or implement particular abstract data types. All or portions of the operating system, applications, modules, and/or data in block 1112 can also be cached in memory such as volatile memory and/or non-volatile memory of the memory subsystem 1104, for example.

The storage subsystem 1106 and memory subsystem 1104 serve as computer readable media for volatile and non-volatile storage of data, data structures, computer-executable instructions, and so on. Such instructions, when executed by a computer or other machine, can cause the computer or other machine to perform one or more acts of a method.

Computer-executable instructions comprise, for example, instructions and data which cause a general-purpose computer, special purpose computer, or special purpose microprocessor device(s) to perform a certain function or group of functions. The computer executable instructions may be, for example, binaries, intermediate format instructions such as assembly language, or even source code. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) exclude (excludes) propagated signals per se, can be accessed by the ES1 806, and include volatile and non-volatile internal and/or external media that is removable and/or non-removable. For the ES1 806, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods and processes of the disclosed architecture.

A user can interact with the ES1 806 programs, and data using external user input devices as part of the I/O subsystem 1116 such as a keyboard and a mouse, as well as by voice commands facilitated by speech and image recognition. Other external user input devices (sensors) can include a microphone, an IR (infrared) remote control, a joystick, a game pad, camera recognition systems, a stylus pen, touch screen, gesture systems (e.g., eye movement, body poses such as relate to hand(s), finger(s), arm(s), head, etc.), and the like. The user can interact with the ES1 806 programs and data using user input devices such a touchpad, microphone, keyboard, etc., where desired, for example.

These and other input devices are connected to the processing unit(s) 1102 through input/output (I/O) subsystem 1116 via the bus system 1108, but can be connected by other interfaces such as a parallel port, IEEE 1394 serial port, a game port, a USB port, an IR interface, short-range wireless (e.g., Bluetooth) and other personal area network (PAN) technologies, etc. The I/O subsystem 1116 also facilitates the use of output peripherals such as printers, audio devices, camera devices, and so on, such as a sound card and/or onboard audio processing capability.

The I/O subsystem 1116 can comprise one or more graphics interface(s) (also commonly referred to as a graphics processing unit (GPU)) provide graphics and video signals on a display of the soft product 100 and/or between the ES1 806 and external display(s) (e.g., LCD, plasma) and/or onboard displays (e.g., for portable computer). The graphics interface(s) can also be manufactured as part of a system board which may be provided for the ES1 806.

The ES1 806 can operate in a networked environment (e.g., IP-based) using logical connections via the wired/wireless transceiver communications subsystem 1110 to one or more networks and/or other devices or computers. The other computers can include workstations, servers, routers, personal computers, microprocessor-based entertainment appliances, peer devices or other common network nodes, and typically include many or all of the elements described relative to the ES1 806. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, mesh networks and mesh nodes, all of which may connect to a global communications network such as the Internet 904.

When used in a networking environment the ES1 806 connects to the network via a wired/wireless transceiver communication subsystem 1110 (e.g., a network interface adapter, onboard transceiver subsystem, etc.) to communicate with wired/wireless networks, wired/wireless printers, wired/wireless input devices, and so on. The transceiver subsystem 1110 of the ES1 806 can include a modem or other means for establishing communications over the network.

In a networked environment, programs and data relative to the ES1 806 can be stored in the remote memory/storage device, as is associated with a distributed system. It will be appreciated that the network connections shown are exemplary and other means of establishing a communications link between the computers can be used.

The ES1 806 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), telephones, cell phones, smart phones and smart devices (e.g., smart TVs), for example. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A soft product, comprising:
a product cover fabricated into the shape of a creature and member parts of the creature, the member parts include a main body and an appendage of the main body;
a compartment system formed into the main body, the compartment system comprising a compartment into which an item can be placed and a compartment cover that mates to the compartment to enable access to the item;
a holder constructed into a member part, the member part at least one of the head or other appendage; and
an electromechanical subsystem located inside the soft product, and for processing at least one of audio, video, or communications signals.

2. The soft product of claim 1, wherein the electromechanical subsystem is accessible via the compartment system.

3. The soft product of claim 1, wherein the electromechanical subsystem includes an audio output component constructed into a member part to output audio signals.

4. The soft product of claim 1, wherein the electromechanical subsystem includes an audio input component constructed into a member part to receive audio signals.

5. The soft product of claim 1, wherein the electromechanical subsystem includes a transceiver system that enables transmission and reception of the audio, video, and communications signals.

6. The soft product of claim 1, wherein the electromechanical subsystem includes at least one of an audio or video player subsystem for processing and playing audio and video data for presentation to a user.

7. The soft product of claim 1, wherein the electromechanical subsystem includes at least one port for receiving a data device from which to access and play at least one of audio or video data.

8. The soft product of claim 1, wherein the electromechanical subsystem includes at least one network port via which at least one of wired or wireless network communication is enabled.

9. The soft product of claim 1, wherein the electromechanical subsystem enables wireless communication with at least one of a cellular-capable or non-cellular device from which to receive and play at least one of audio, data, or video signals, and to which to transmit at least one of audio, data, or video signals.

10. The soft product of claim 1, wherein the electromechanical subsystem includes a mesh network node capability that functions as a mesh node in a mesh network.

11. The soft product of claim 1, wherein the electromechanical subsystem includes a display which enables the presentation of video signals.

12. The soft product of claim 1, wherein the electromechanical subsystem includes a speech recognition subsystem for processing speech signals from a user and outputting an audio signal to the user.

13. The soft product of claim 1, wherein the electromechanical subsystem includes a data storage subsystem that enables the storage of software data, software data updates, and user-supplied data.

14. The soft product of claim 1, wherein the electromechanical subsystem includes electromechanical components in the member parts that are controlled by a microprocessor to activate in a specific way in response to at least one of speech or a gesture communicated from the user to the soft product.

15. A soft product, comprising:
a product cover fabricated into the shape of a creature and member parts of the creature, the member parts include a main body and an appendage of the main body;
a compartment system formed into the main body, the compartment system comprising a compartment into which an item can be placed and a compartment cover that mates to the compartment to enable access to the item;
a holder constructed into a member part, the member part at least one of the head or other appendage; and
an electromechanical subsystem located inside the soft product, and for processing at least one of audio, video, or communications signals, the electromechanical subsystem includes:
an audio output component constructed into a member part to output audio signals;
a transceiver system that enables transmission and reception of the audio, video, and communications signals;
at least one of an audio or video player subsystem for playing audio and video data for presentation to a user;
at least one port for receiving a data device from which to access and play at least one of audio or video data; and
a data storage subsystem that enables the storage of software programs and data, software program and data updates, and, user-supplied program and data inputs.

16. The soft product of claim 15, wherein the electromechanical subsystem is accessible via the compartment system.

17. The soft product of claim 15, wherein the electromechanical subsystem includes an audio input component constructed into a member part to receive audio signals.

18. The soft product of claim 15, wherein the electromechanical subsystem includes at least one network port via which at least one of wired or wireless network communication is enabled.

19. The soft product of claim 15, wherein the electromechanical subsystem enables wireless communication with at least one of a cellular-capable or non-cellular device from which to receive and play at least one of audio, data, or video signals, and to which to transmit at least one of audio, data, or video signals.

20. A soft product, comprising:
a product cover fabricated into the shape of a creature and member parts of the creature, the member parts include a main body and an appendage of the main body;
a compartment system formed into the main body, the compartment system comprising a compartment into which an item can be placed and a compartment cover that mates to the compartment to enable access to the item;
a holder constructed into a member part, the member part at least one of the head or other appendage; and
an electromechanical subsystem located inside the soft product, and for processing at least one of audio, video, or communications signals, the electromechanical subsystem includes:
a transceiver system that enables transmission and reception of the audio, video, and communications signals;
a speech recognition subsystem for processing speech signals from a user and outputting an audio signal to the user;
a video recognition subsystem for processing images received from a camera subsystem;
electromechanical components in the member parts controlled by a microprocessor to activate in a specific way in response to at least one of speech or a gesture communicated from the user to the soft product; and
a data storage subsystem that enables the storage of software programs and data, software program and data updates, and, user-supplied program and data inputs.
